(19) United States
(12) Patent Application Publication
(10) Pub. No.: US 2018/0025602 A1
(43) Pub. Date: Jan. 25, 2018

(54) ANTI-THEFT SAFETY DEVICE WITH PROTECTION FROM INJURIES

(71) Applicant: Piero NECCHI, BORGORATTO, AL (US)

(72) Inventor: Piero NECCHI, BORGORATTO, AL (US)

(21) Appl. No.: 15/549,460

(22) PCT Filed: Feb. 13, 2015
(86) PCT No.: PCT/IT2015/000038

§ 371 Date: Aug. 8, 2017

(51) Int. Cl. G08B 13/24; E05B 73/00

(52) U.S. Cl. CPC G08B 13/2434; E05B 73/0023

(57) ABSTRACT

An anti-theft safety device with protection from injuries is described, equipped with crimping means, guiding means, housing means and locking means of such crimping means, such device comprising at least one connecting structure between such guiding means and such housing means of the crimping means in order to keep such housing means and such locking means permanently aligned with at least such crimping means, and to prevent said crimping means from injuring a user.

The present invention refers to a safety device with protection from injuries, particularly aimed for the anti-theft protection of products exhibited for sale.

As known, the prior art proposes anti-theft devices suitable to protect objects such as, but not only, compact discs, DVDs, music cassettes, videocassettes and the like, eyeglasses, bottles, clothes and the like. These devices are activated on the product to be protected exhibited for sale and removed after its sale.

Such devices are divided into:
anti-theft containers, generally made of transparent polycarbonate, suitable to prevent the theft of compact discs, music cassettes, videocassettes, DVDs, books or the like, placed therein during their exhibition for sale;
adjustable anti-theft devices, particularly aimed for protecting against the theft of products contained inside encumbrant boxes or packets equipped with a safety coil connected through a plurality of wires with adjustable length to an abutment plate, such wires being adapted to surround all sides of an envelope containing the product to be protected during its exhibition for sale;
anti-theft and safety devices for bottles;
anti-theft tags, typically applied on clothes and the like.

In general, such devices are equipped with safety systems, of the radiofrequency, electromagnetic, acoustic-magnetic types, labels and other recognizing systems, a combination of these safety systems cooperating with a system for detecting obstacles.

In particular, such safety systems can comprise:
a magnetic device with ferrite core adapted to detect obstacles and cooperate with the anti-theft device;
an opening-preventing device adapted to emit a sound alarm signal in case of forced opening of the anti-theft device;
a device composed of a combination of two devices: a first device adapted to emit an alarm signal, both in case of forced opening, and in case of illegal passage between the barriers detected through a ferrite core and a second device for recognizing a code sent by an extraction device adapted to deactivate an anti-theft mechanism.

In particular, EP1869275 discloses an anti-theft safety device comprising a first closing element equipped with at least one nail and a second closing element equipped with means for catching the nail, in which the first and the second closing elements are mutually airtightly joined when the nail is inserted in the catching means. Such device comprises elastic returning means adapted to allow placing the nail in a suitable housing when the first closing element is separated from the second closing element when opening the safety device, in order to prevent the nail to project from the first closing element.

The device according to EP1869275 is therefore subjected to be improved in order to finally remove the chance of making the nail go out from its own seat, while the two closing elements are not assembled one with respect to the other.

Object of the present invention is therefore solving the above prior art problems, by providing an anti-theft safety device in which the nail of the first closing element remains arranged facing and adjacent to the second closing element equipped with means for catching such nail, even when such device is open, in order to prevent the nail from going out and injurying a user.

Another object of the present invention is providing an anti-theft safety device which can be activated without having to center and guide the nail to be able to reach its own seat.

The above and other objects and advantages of the invention, as will appear from the following description, are obtained with an anti-theft safety device as claimed in claim 1. Preferred embodiments and non trivial variations of the present invention are the subject matter of the dependent claims.

It is intended that all enclosed claims are an integral part of the present description.

It will be immediately obvious that numerous variations and modifications (for example related to shape, sizes, arrangements and parts with equivalent functionality) could be made to what is described, without departing from the scope of the invention as appears from the enclosed claims.

The present invention will be better described by some preferred embodiments thereof, provided as a non-limiting example, with reference to the enclosed drawings, in which:

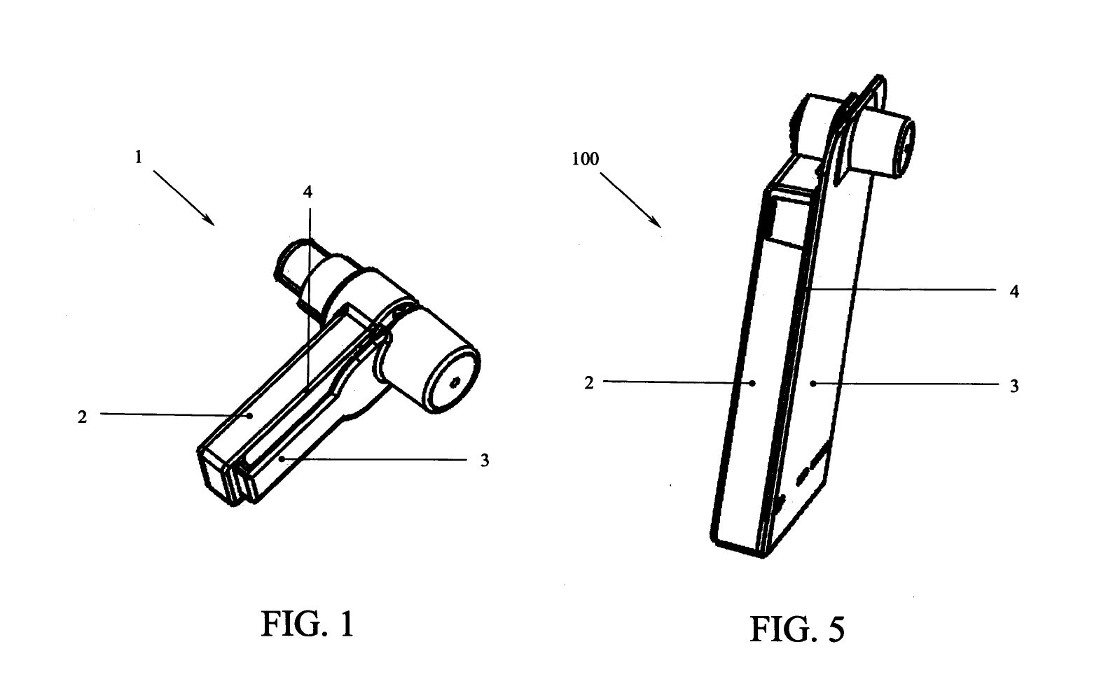

FIG. 1 shows a perspective view in an unlocked configuration of a first preferred embodiment of the anti-theft safety device according to the present invention;

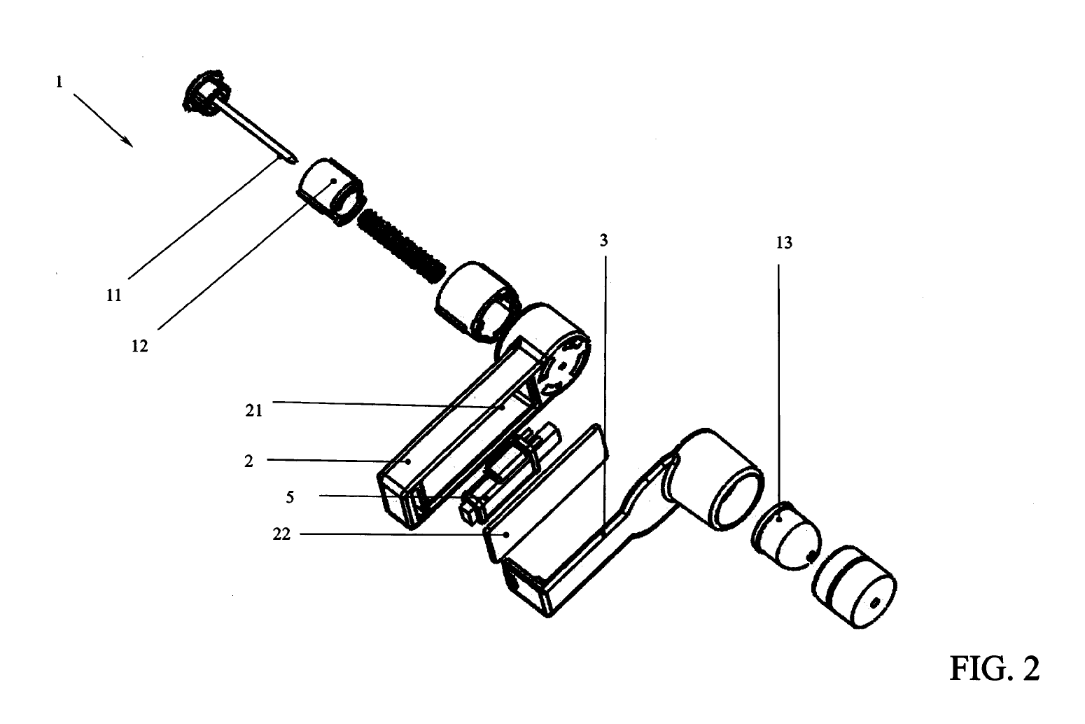

FIG. 2 shows an exploded perspective view of the device of FIG. 1;

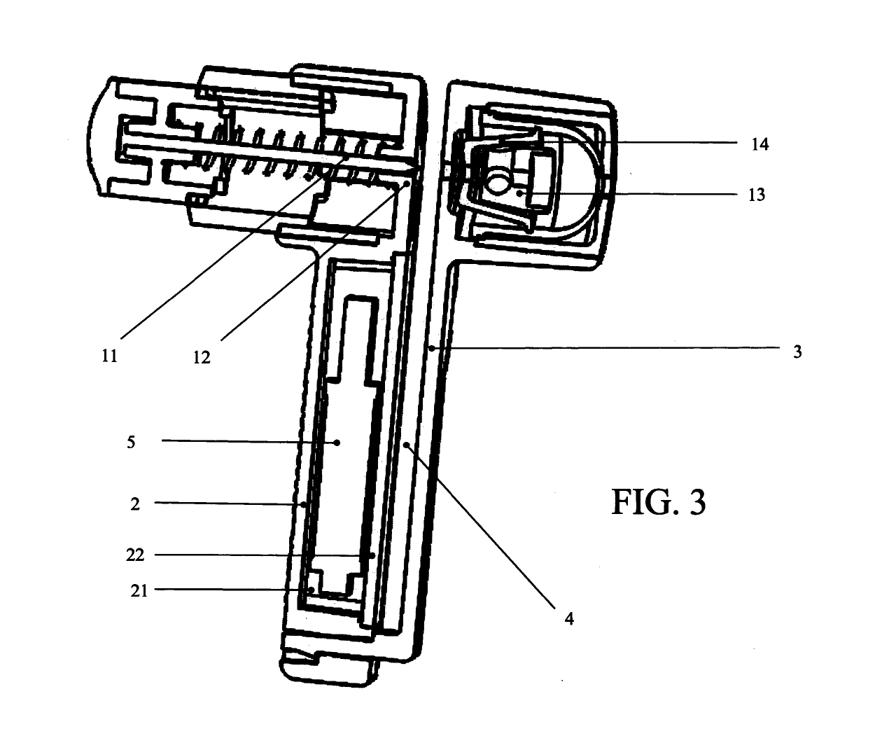

FIG. 3 shows a side sectional view of the device of FIG. 1;

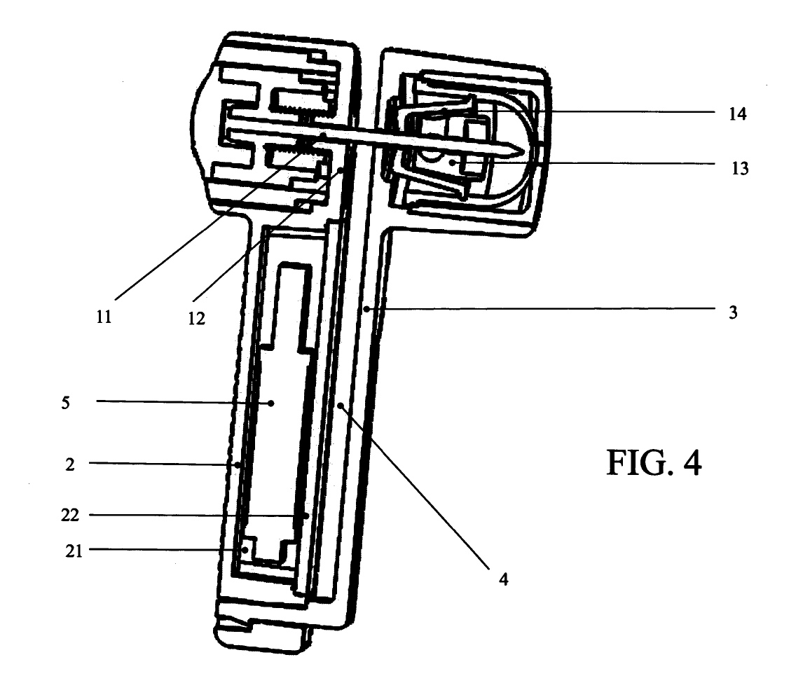

FIG. 4 shows a side sectional view, in a locked configuration, of the anti-theft safety device of FIG. 1;

FIG. 5 shows a perspective view, in a locked configuration, of a second preferred embodiment of the anti-theft safety device according to the present invention; and

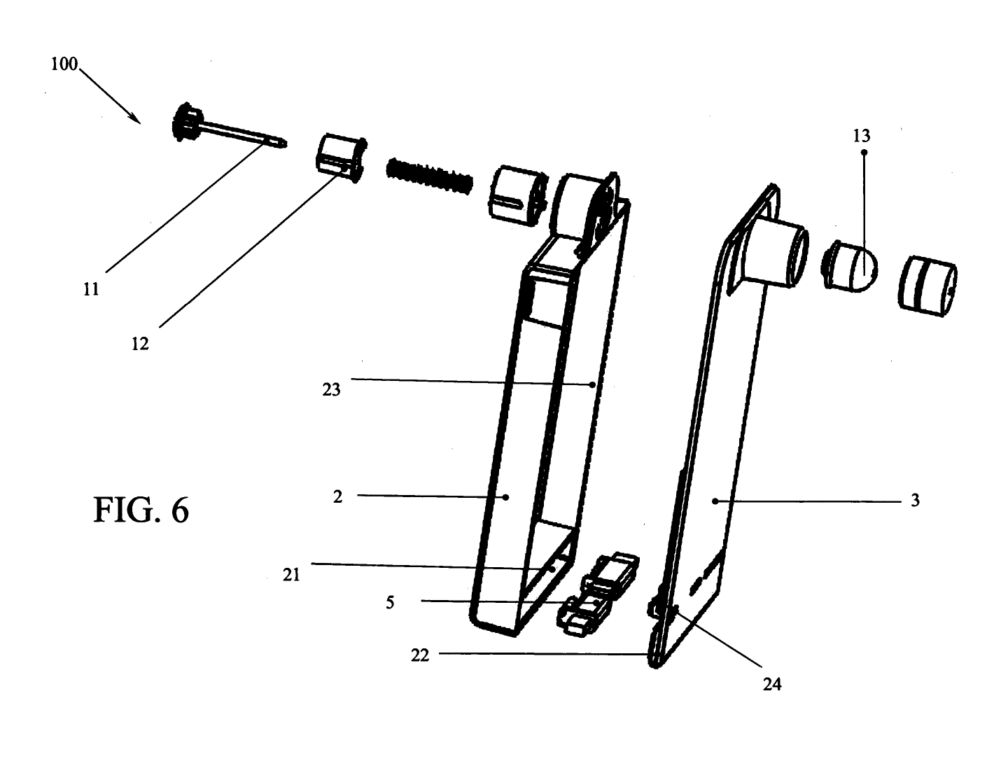

FIG. 6 shows an exploded perspective view of the device of FIG. 5.

With reference to the Figures, it is possible to note that an anti-theft safety device 1 is equipped with crimping means 11, guiding means 12, housing means 13 and locking means 14 of the crimping means 11.

Advantageously, the anti-theft safety device 1 according to the present invention further comprises at least one connection structure 2, 3 between the guiding means 12 and the housing means 13 of the crimping means 11 in order to keep such housing means 13 and such locking means 14 permanently aligned with such crimping means 11 in order to avoid that the crimping means 11, in the unlocked configuration of the device 1, are exposed with risks of injuries for the users and to allow blocking the crimping means 11 in the locking means 14 without having to use centering means.

In particular, the crimping means 11 comprise at least one nail, possibly sliding by means of a telescopic tube belonging to the guiding means 12, adapted to reach a seat belonging to the housing means 13 and remain blocked by means of at least one sphere adapted to press against the nail by means of a spring belonging to the locking means 14.

In a first preferred embodiment, like the one in FIGS. 1 to 4, the device 1 according to the present invention can be used for the anti-theft protection of pieces of clothing and the structure 2, 3 can be elastically deformed to allow positioning the piece of clothing to be protected before its crimping, with respect to the crimping means 11.

According to such first preferred embodiment, the structure 2, 3 comprises a first and a second support connected through a joint adapted to obtain a space 4 to allow positioning the piece of clothing to be protected, with respect to the crimping means 11.

In a second preferred embodiment, like the one of FIGS. 5 and 6, the device 1 according to the present invention can be used for the anti-theft protection of packages of electronic and/or informatics products, such as SD memory cards, USB keys, etc. According to such second preferred embodiment, the structure 2, 3 is composed of at least one container composed of a rear element 3 and of a front element 2 which can be assembled to internally define at least one containing room 23 adapted to contain therein at least one package of such product. Moreover, inside such containing room 23, the structure 2, 3, and in particular the rear element 3, can comprise at least one withdrawal preventing profile 24 adapted to abut and compress at least one portion of the package to prevent it from being withdrawn from inside the containing room 23 when such rear element 3 and such front element 2 are assembled.

Moreover, in order to make the anti-theft action efficient, the structure 2, 3 comprises at least one detecting system 5 with radiofrequency (RF), electromagnetic (EM) or acoustic-magnetic (AM) with ferrite core (not shown) or their combinations cooperating with the anti-theft detection barriers and/or at least one RFID element (not shown), according to the prior art. In particular, as it is possible to note for example in FIG. 2, the structure 2, 3 can comprise at least one room 21 closed by a cover 22 to be able to house therein such detecting system 5. Alternatively, as it is possible to note for example in FIG. 5, the room 21 can be integrally housed inside the structure 2, 3.

1-8. (canceled)

9. An Anti-theft safety device comprising:
a. a housing;
b. a guiding means connected to the housing;
c. a crimping means connected to the housing; and
d. a locking means connected to the housing.

10. The anti-theft device of claim 9, where the crimping means comprises at least one connecting structure between the guiding means and the housing in order to keep the housing and the locking means permanently aligned with the crimping means, and to prevent the crimping means from injuring a user.

11. The anti-theft device of claim 9, where the crimping means comprises at least one sliding nail to reach a seat belonging to the housing and remain blocked by at least one sphere adapted to press against the nail by means of a spring belonging to the locking means.

12. The anti-theft device of claim 11, where the structure is adapted to be elastically deformed to allow positioning a piece of clothing to be protected with respect to the crimping means.

13. The anti-theft device of claim 12, where the structure comprises a first and a second support connected through a joint adapted to obtain a space to allow placing the piece of clothing to be protected, with respect to the crimping means.

14. The anti-theft device of claim 10, where the structure comprises at least one container, where the container comprises a rear element and at least one front element which can be assembled to internally define at least one containing room adapted to contain therein at least one package of a product.

15. The anti-theft device of claim 14, where the inside of the containing room, the structure, and the rear element, comprise at least one withdrawal preventing profile adapted to abut and compress at least one portion of the package to prevent its withdrawal from inside the containing room when the rear element and the front element are assembled.

16. The anti-theft device of claim 9, further comprising at least one detecting system selected from the group consisting of a radiofrequency, an electromagnetic, and an acoustic-magnetic with ferrite core

17. The anti-theft device of claim 16, further comprising at least one RFID element inside the structure.

18. The anti-theft device of claim 16, where the structure comprises a room closed by a cover, the room adapted to house the detecting system.
